(19) United States
(12) Patent Application Publication
(10) Pub. No.: US 2024/0007993 A1
(43) Pub. Date: Jan. 4, 2024

(54) METHOD AND APPARATUS FOR LOCATING EMITTERS IN A CELLULAR NETWORK

(71) Applicant: Focal Point Positioning Limited, Cambridge (GB)

(72) Inventors: RAMSEY MICHAEL FARAGHER, Cambridge (GB); Robert Mark CROCKETT, Cambridge (GB); Peter James DUFFETT-SMITH, Cambridge (GB)

(21) Appl. No.: 18/216,431

(22) Filed: Jun. 29, 2023

Related U.S. Application Data
(60) Provisional application No. 63/357,270, filed on Jun. 30, 2022.

(30) Foreign Application Priority Data
Mar. 2, 2023 (WO) PCT/EP2023055379

(51) Int. Cl. H04W 64/00; G01S 5/00; G01S 5/02

(52) U.S. Cl. CPC H04W 64/006; G01S 5/01; G01S 5/0269

(57) ABSTRACT

A method, apparatus, and system for determining locations of cellular emitters include receiving at least one signal from the cellular emitters at an antenna of at least one receiver, determining a motion of the antenna of the at least one receiver that received the at least one signal, using the determined antenna motion, performing motion compensated correlation upon the at least one received signal to generate at least one motion compensated correlation result, determining a direction of arrival for the at least one received signal using the at least one motion compensated correlation result, and determining a location of the cellular emitters using the direction of arrival of the at least one received signal and a known location of the at least one receiver. A geolocation map of the locations of the emitters of, for example, cell base station towers can be generated using determined emitter locations.

### CROSS-REFERENCE TO RELATED APPLICATIONS

This application claims benefit of U.S. Provisional Patent Application Ser. No. 63/357,270 filed Jun. 30, 2022 and PCT Application Serial No. PCT/EP2023/055379 filed Mar. 2, 2023, which are herein incorporated by reference in their entireties.

### BACKGROUND

### Field

Embodiments of the present invention generally relate to radio communications and, in particular, to a method and apparatus for locating signal sources, for example, emitters in a cellular network.

### Description of the Related Art

Cellular telephone networks are designed as a network of interconnected cells where each cell has a centrally located tower or other structure supporting antennas for a signal source, such as an emitter/antenna of a cell base station tower, that communicate with mobile transceivers operating in a 0.1 to 10 km radius. In many instances, the antennas have stationary positions upon tall buildings, water towers, telephone poles, light poles or any structure with substantial height to form a cellular mast. Historically, the mast locations have not been mapped with any accuracy. Older cellular telephone standards communicated over substantial, overlapping regions. As such, accuracy of mast placement was not critical. Newer cellular telephone standards, however, have much smaller operating radiuses (e.g., 100 to 300 meters) and require more accurate mast placement. In addition, without accurate knowledge of antenna locations, repair and upgrade procedures can be difficult, if not impossible.

Furthermore, if a communication system is designed for performing positioning, such as a 5G cellular system, an accurate understanding of the communication system transceiver emitters/antennas of a cell base station tower is critical to performing accurate positioning of mobile transceivers.

Therefore, there is a need for methods, apparatuses, and systems for locating and/or mapping fixed signal sources, for example, emitters/antennas of a cell base station tower in a cellular network.

### SUMMARY

Embodiments of the present principles generally relate to a method, apparatus, and system for locating emitters in a cellular network as shown in and/or described in connection with at least one of the figures.

In some embodiments, a method, apparatus, and system for determining a location of a cellular emitter includes receiving at least one signal from the at least one emitter at a respective antenna of at least one receiver, determining a motion of the respective antenna of the at least one receiver that received the at least one signal from the at least one emitter, using the determined antenna motion, performing motion compensated correlation upon the at least one received signal to generate at least one motion compensated correlation result, determining a direction of arrival for the at least one received signal using the at least one motion compensated correlation result, and determining a location of the at least one emitter using the direction of arrival of the at least one received signal and a known location of the at least one receiver. In some embodiments of the present principles, the location of multiple emitters can be determined and mapped to provide a geolocation map of emitter locations.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a particular description of the invention, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a communication environment in which an embodiment of the present principles can be applied in accordance with an embodiment of the present principles;

FIG. 2 depicts a high-level block diagram of a receiver of the present principles in accordance with an embodiment of the present principles;

FIG. 3 depicts a graphic representation of the functionality of a receiver of the present principles in accordance with at least one embodiment of the present principles;

FIG. 4 depicts a flow diagram of a method for determining a location of at least one emitter in accordance with an embodiment of the present principles;

FIG. 5 depicts a method for determining geolocation parameters for at least one cellular in accordance with at least one embodiment of the present principles; and

FIG. 6 depicts a graphical representation of the functionality of a receiver of the present principles in accordance with an alternate embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles provide apparatuses, methods and systems for locating signal sources such as emitters/antennas of a cell base station tower in, for example, a cellular network. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific signals originating from specific emitters and being received by specific receivers, embodiments in accordance with the present principles can be applied to substantially any radio signals originating from substantially any signal source and being received by substantially any receiver.

In the present disclosure, the terms “emitter/antenna”, “remote source” and “signal source” can be used interchangeably and are intended to refer to and define a source of a communication signal from, for example, a cell base station tower in a cellular network.

In the present disclosure, the concept of and phrase “location information” is intended to describe and define a position, be it absolute or relative, to a receiver for example, or, for example, a geolocation. In some embodiments, the location information can include a geolocation of a remote signal source, and it will be understood that, in at least some embodiments, the location information pertains to a location of an emitter/antenna of the remote signal source of a cell base station tower in a cellular network.

In the present disclosure, in some embodiments the concept of identifying a direction can be equated to calculating or generating a vector.

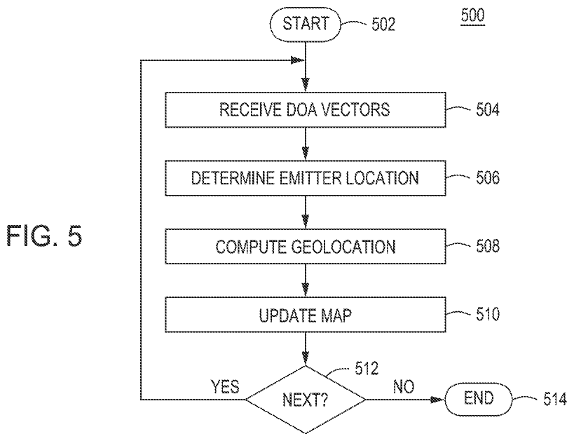

In accordance with embodiments of the present principles, movement of a receiver of the present principles through an area enabling communication with, for example, an emitter/antenna of a cell base station tower in a cellular network s need only be sufficient for performing the described motion-compensated correlation of the present principles. That is in some embodiments, the movement of a receiver of the present principles comprises a component directed along a direction parallel to the direction of an arrival vector of a signal from, for example, an emitter/antenna of a cell base station tower in a cellular network, and to a spatial and/or temporal extent that allows the compensation calculations to be made. However, no movement of the receiver other than that which enables the motion-compensated correlation to be performed need necessarily be performed in order for the described generating of location information in accordance with at least some embodiments the present principles. Therefore, the extent of any receiver movement, or any component thereof, which is transverse to the direction of arrival and/or to a straight line between the receiver and the emitter/antenna, need not be sufficiently great that an angle subtended by that movement or component at the emitter/antenna, and/or at a location at which a signal is reflected towards the receiver is large enough to permit or facilitate the calculation of location information. Rather, in some embodiments, movement of the receiver can, in some cases, be insufficient for that purpose as such, with the calculation of any intersection locations instead (or additionally) being based on direction of arrival (DoA) vector differences that are attributable to differences in signal propagation paths. Therefore, a difference in the direction of signal receipt for any two or more signals received, in some embodiments, result from a propagation path of one or more of those signals including one or more changes in direction, that is from one or more of those signals having been reflected. In this way, two sufficiently different remote source vectors, corresponding to two different transmission angles can be obtained, and an intersection location of those vectors calculated, regardless of whether the receiver has moved to an extent that enables triangulation of line-of-sight vectors to the source, for example an emitter/antenna of a cell base station tower in a cellular network. More specifically, in some embodiments by including one or more reflected signals in the basis for the calculations, a location of a remote source can still be identified even if the receiver does not move sufficiently to enable sufficiently precise triangulation based on two line-of-sight signal vectors (described in greater detail with respect to the embodiment 500 of FIG. 5).

In some embodiments, a determination of location information for a signal source in accordance with the present principles can be performed, for example, such that location information comprises a point corresponding to an average, in particular a mean location of multiple locations at which, in some embodiments, two or more of identified remote source vectors intersect. The generating of the location information can also be understood as being based on one or more locations of intersection. Each location of intersection can correspond to a point, or a one-, two-, or three-dimensional region defined by an intersection between two remote source vectors. In some embodiments, an absolute location of a remote source, with respect to an established coordinate system for example, such as geolocation data, can be determined by way of locating the receiver in that coordinate system. Accordingly, in some embodiments location information for an emitter/antenna of a cell base station tower in a cellular network can be generated based on known location information for the receiver. In some embodiments, the receiver location can be determined using GNSS (Global Navigation Satellite System) and/or IMU (Inertial Measurement Unit) data, and can additionally be determined based on determined movement of the receiver, such as respective determined movement corresponding to any one or more received signals from the signal source.

Embodiments of the present principles provide methods, apparatuses and systems for determining locations of signal sources, such as emitters/antennas of a cell base station tower in a cellular network. In general, the methods, apparatuses and systems of the present principles can receive at least one RF signal from an emitter/antenna, perform motion compensated correlation upon the at least one signal, and determine the direction of arrival (DoA) of the at least one signal from the emitter/antenna. The determined DoA information can be used along with known location information of a receiver receiving the emitter/antenna signal to determine a location for the emitter/antenna. In some embodiments of the present principles, determined DoA information can include a vector corresponding to or representative of the direction from which the signal is received at the receiver, and/or the direction of travel of the signal as it is received at the receiver. In some embodiments, for line-of-sight signals, the DoA and remote source vector typically correspond to the same direction and can be thought of as parallel and typically having collinear vectors. For non-line-of-sight signals, line-of-sight signals can be used to enhance non-line-of-sight signals, and determined DoA information can be used in conjunction with knowledge of the reflective structures in the vicinity, such as any one or more of position, orientation, shape, of one or more reflective surfaces or objects, to determined remote source vectors. In such embodiments, the additional non-line-of-sight data, and specifically the additional remote source vectors determined based on DoAs that do not directly correspond to the direction in which the signal was received from the signal source, add to improved accuracy of locations determined for signal sources. The additional remote source vectors can also be useful if, for example, line-of-sight signals from a given signal source are occluded.

Embodiments of the present principles enable signal sources, such as emitters/antennas of a cell base station tower in a cellular network, to be located using receivers with antennae that are structurally simple, obviating the need for a multielement antenna, any mechanical steering of an antenna, or any complex antenna designs, arrangements, or arrays, all of which have conventionally been used for source positioning. For example, a receiver of the present principles can receive signals from a source using a single-element antenna, and in particular a single-element dipole antenna. As such, embodiments of the present principles are particularly suitable for performing source location using receivers such as cellphones using signals being received by a cellphone antenna. Such antennae are typically provided as single-element antennae.

Cellular telephone systems utilize digital signals to improve communication throughput and security. Most of these systems utilize some form of deterministic digital code to facilitate signal acquisition, including but not limited to Gold codes, training sequences, synchronization words, and/or channel characterization sequences. Such a digital code is deterministic by the receiver and repeatedly broadcast by the transmitter to enable communications receivers to acquire and receive the transmitted signals. Embodiments of the present principles use such deterministic codes, combined with an accurate motion model of a receiver of the present principles, to identify a direction of arrival (DoA) of a received signal to determine a propagation path between a receiver of the present principles and a transmitter/emitter of the signal. In some embodiments, a technique for determining a DoA of received signals using receiver motion information in accordance with the present principles is known as SUPERCORRELATION™ and is described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020, which are hereby incorporated herein by reference in their entireties. In accordance with the present principles, a receiver of the present principles can use determined DoA data to identify a location of cellular emitters. A map of the cellular emitters can be created using the identified locations.

For example, receivers of the present principles transported through an area containing cellular emitters are capable of identifying the locations of each nearby emitter. Such receivers can be carried by humans and, in some embodiments, the functionality of the present principles can be added to receivers of the present principles via application software. The information determined by the receivers of the present principles can be implemented to map emitters in proximity to a respective receiver. Alternatively or in addition, in some embodiments, receiver motion can be established by moving the receiver using a vehicle on a ground path and/or by moving the receiver using an airborne vehicle, manned or unmanned (e.g., drones, helicopters, airplanes, etc.).

As a receiver of the present principles moves across an area, the receiver collects data from cellular emitters that can be used to determine respective DoA information for the cellular emitters that are nearby (i.e., within a transmission range of the emitter). A communication distance for each emitter can vary depending on the cellular standard used by the emitter. For example, communication from a 3G based emitter can be received up to 50 km away from the emitter, while communication from a 5G based emitter can be received only 100 m away from the emitter.

A receiver of the present principles can determine its location using an included global navigation satellite system (GNSS) receiver and/or an inertial guidance system. In accordance with the present principles, the motion and/or location information of the receiver along with determined DoA vectors (representing direction of arrival of a signal from an emitter to a receiver) to a particular emitter, can be implemented to compute a location of at least one emitter relative to a respective receiver. In some embodiments, a determined emitter location can then be translated to a geocoordinate. As emitter locations are computed, a geocoordinate map can be produced showing the respective locations of the emitters and, more specifically, the cellular emitter masts.

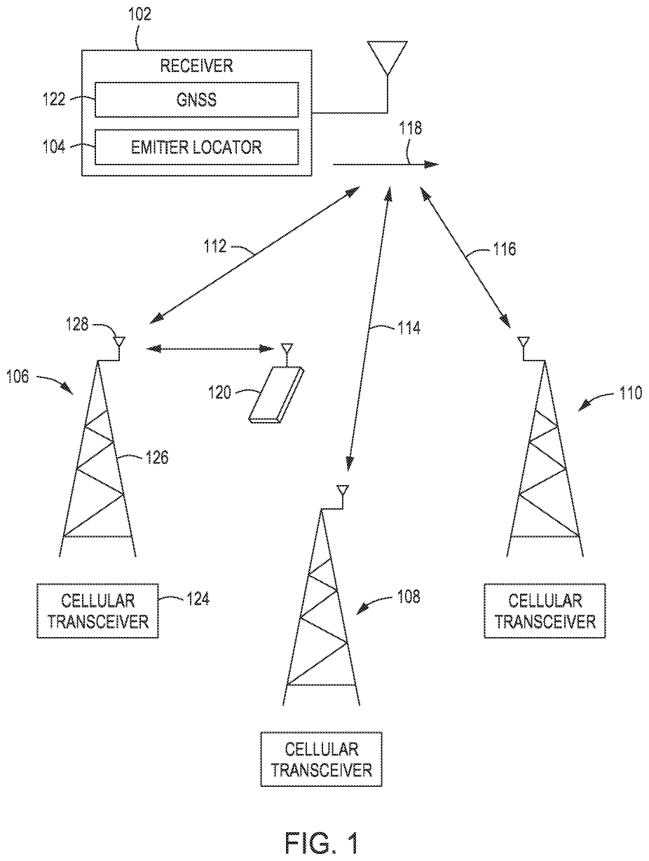

FIG. 1 depicts a block diagram of a communication environment 100 in which an embodiment of the present principles can be applied in accordance with an embodiment of the present principles. The communication environment 100 of FIG. 1 illustratively comprises a receiver 102 and three cellular emitters 106, 108 and 110. In the embodiment of FIG. 1, each emitter comprises a cellular transceiver 124₁-124₃, a mast 126₁-126₃, and an antenna 128₁-128₃ operating together as a conventional, fixed location cellular base station. The receiver 102 comprises an emitter locator 104 configured to receive and process signals transmitted by the cellular emitters 106, 108, 110 (three emitters are depicted, but the receiver 102 can process the signals from any number of emitters). The signals from the emitters 106, 108 and 110 are intended to communicate with a cellular mobile device 120, including but not limited to, a cellular telephone, a laptop computer, a tablet, Internet of Things (IoT) devices, and the like, that communicate using cellular signals, e.g., CDMA, GSM and the like that support cellular standards such as, but not limited to, 3G, 4G, LTE, and/or 5G standards. In some embodiments, the cellular mobile device 120 can include a receiver 102 of the present principles.

Although in the embodiment of FIG. 1, the emitter locator 104 is depicted as being an integrated component of the receiver 102, in alternate embodiments of the present principles, an emitter locator of the present principles can comprise a component separate from the receiver 102 and in some embodiments can comprise a stand-alone component. In such embodiments, an emitter locator of the present principles can be located remotely from the receiver 102 and the signals captured by the receiver 102 can be communicated to the remote emitter locator for determining a location of an emitter in accordance with the present principles.

The receiver 102 of FIG. 1 further comprises a global navigation satellite system signal (GNSS) receiver 122 that works with the emitter locator 104 to accurately locate the cellular emitters 106, 108, 110 in accordance with at least one embodiment of the present principles. As described in greater detail below, the emitter locator 104 can use a SUPERCORRELATION™ technique as described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020, which are hereby incorporated herein by reference in their entireties. The SUPERCORRELATION™ technique determines a direction of arrival (DoA) of received signals 112, 114, 116. As the receiver 102 moves within the communication environment 100 (represented by arrow 118), the emitter locator 104 computes motion information representing motion of the receiver 102. The motion information is used to perform motion compensated correlation of the received signals 112, 114, 116. From the motion compensated correlation process, the emitter locator 104 estimates the DoA of each of the signals 112, 114, 116. The GNSS receiver 122 of the receiver 102 provides an accurate location for the receiver 102. In some embodiments, the GNSS receiver 122 can include or operate in conjunction with an inertial navigation system (INS) (not shown). The emitter locator 104 uses the receiver position/location along with the DoA data to determine a location of the emitters 106, 108, 110. The intersection of a plurality of DoA vectors generated as the receiver moves along path 118 identifies the location of the emitters 106, 108, 110 as described in greater detail below.

Using the determined locations of each of the emitters 106, 108, 110, in some embodiments, the receiver 102 can create a map of the emitter locations. In one embodiment, the location information of the emitters 106, 108, 110 can be stored in a storage location accessible to the receiver 102 and downloaded to a mapping application at a later time. In an alternative embodiment, the emitter locations may be continuously, periodically, or intermittently transmitted via cellular or WiFi communications to a server (not shown) where a mapping application can create a map of the locations of the emitters 106, 108, 110.

Although in the embodiment of FIG. 1, the receiver 102 includes an emitter locator 104 at which DoA information and location information is determined for the emitters 106, 108, 110, alternatively or in addition, in some embodiments of the present principles, information regarding signals/data received at the receiver 102 can be communicated to and processed within at least one remotely located server. That is, in such embodiments of the present principles, the remote server(s) can perform the emitter locator function described above by, for example, using an emitter locator of the present principles, such as the emitter location 104 of FIG. 1.

In some embodiments of the present principles, there can be multiple receivers that cooperate to capture emitter signals and determine respective DoA information for the emitters in accordance with the present principles. In such embodiments, the information collected and determined from at least some or all of the receivers of the present principles can be used in accordance with the present principles to determined location information for at least one emitter from which signals were received. For example, in some embodiments, signals from a single emitter can be captured by multiple receivers of the present principles. In such embodiments, DoA information determined from the received emitter signals captured by the multiple receivers can be used to determine location information for the single emitter. For example, in such embodiments, triangulation can be used to determine a location of the single emitter based on the location information determined by at least some of the multiple receivers of the present principles.

In some embodiments of the present principles, a receiver of the present principles, such as the receiver 102 of FIG. 1, can determine time of arrival (TOA) or time difference of arrival (TDOA) information from signals received from at least one emitter. The TOA and TDOA information can be used by a receiver of the present principles for determining a location of a respective emitter(s) from which signals were received (described in greater detail below). That is, in some embodiments, determined TOA and TDOA information can be used to augment DoA vector processing to improve a speed at which a position solution/location information is determined for respective emitter(s).

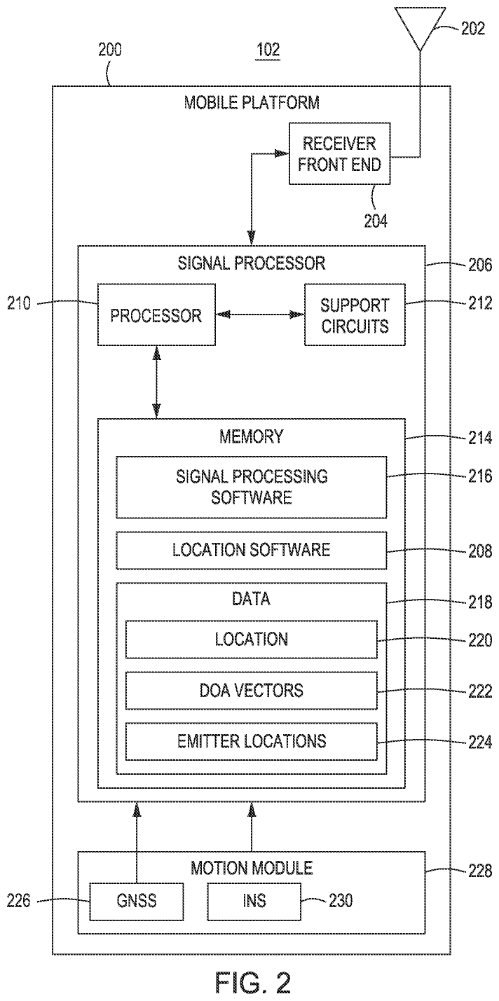

FIG. 2 depicts a high-level block diagram of a receiver of the present principles, such as the receiver 102 of FIG. 1, in accordance with an embodiment of the present principles. The receiver 102 of FIG. 2 comprises a mobile platform 200, an antenna 202, receiver front end 204, a signal processor 206, and a motion module 228. The receiver 102 of FIG. 2 can comprise a component of a mobile device, including but not limited to a laptop computer, a mobile phone, a tablet computer, an Internet of Things (IoT) device, an unmanned aerial vehicle, a mobile computing system in an autonomous vehicle, a human operated vehicle, and the like. Although in the embodiment of FIG. 2, the signal processor 206 and the motion module 228 are depicted as being an integrated component of the receiver 102/mobile platform 200, in alternate embodiments of the present principles, at least one of a signal processor and/or a motion module of the present principles can comprise a component separate from the receiver 102/mobile platform 200 and in some embodiments can comprise a stand-alone component. In such embodiments, at least one of a signal processor and/or a motion module of the present principles can be located remotely from the receiver 102 and the signals captured by the receiver 102 can be communicated to the remote at least one of a signal processor and/or a motion module of the present principles for determining a location of an emitter in accordance with the present principles.

In the receiver 102 of FIG. 2, the mobile platform 200 and the antenna 202 are, illustratively, an indivisible unit in which the antenna 202 moves with the mobile platform 200. The operation of the SUPERCORRELATION™ technique of the receiver 102 operates based upon determining the motion of the signal receiving antenna 202 of the receiver. With respect to the embodiment of the receiver 102 of FIG. 2, any mention of motion refers to the motion of the antenna 202. Alternatively, in some embodiments of the present principles, a receiver antenna can comprise a separate component from a mobile platform. In such embodiments, the motion estimate used in the motion compensated correlation process of the present principles is the motion of the antenna. In most instances however, the motion of the mobile platform 200 is the same as the motion of the antenna 202 and, as such, the following description will be described with the notion that the motion of the platform 200 and the antenna 202 are the same.

In the receiver 102 of FIG. 2, the mobile platform 200 comprises a receiver front end 204, a signal processor 206 and a motion module 228. The receiver front end 204 down-converts, filters, and samples (digitizes) received signals from at least one emitter. The output of the receiver front end 204 is a digital signal containing data including at least a deterministic training or acquisition code. The deterministic training or acquisition code, e.g., Gold code, is included in a signal from the at least one cellular emitter to synchronize the transmission to a cellular transceiver.

The signal processor 206 comprises at least one processor 210, support circuits 212 and a memory 214. The at least one processor 210 can be any form of processor or combination of processors including, but not limited to, central processing units, microprocessors, microcontrollers, field programmable gate arrays, graphics processing units, digital signal processors, and the like. The support circuits 212 can comprise well-known circuits and devices facilitating functionality of the processor(s). The support circuits 212 can further comprise one or more of, or a combination of, power supplies, clock circuits, analog to digital converters, communications circuits, cache, displays, and/or the like.

The memory 214 comprises one or more forms of non-transitory computer readable media including one or more of, or any combination of, read-only memory or random-access memory. The memory 214 stores software and data including, for example, signal processing software 216, emitter location software 208 and data 218. The data 218 can include the receiver location 220, direction of arrival (DOA) vectors 222 (collectively, DoA data), emitter locations 224, and various data used to perform the SUPERCORRELATION™ processing. The signal processing software 216, when executed by the one or more processors 210, performs motion compensated correlation upon the received signals to estimate the DoA vectors for the received signals in accordance with the present principles. The motion compensated correlation process is described in detail below. In some embodiments of the present principles, the signal processing software 216 can perform the described functionality of the emitter locator 104 of FIG. 1.

As described below in detail, the DoA vectors 222 and receiver location 220 are used by the emitter location software 208 to determine the location of each emitter. The data 218 stored in memory 214 can also include signal estimates, correlation results, motion compensation information, motion information, motion and other parameter hypotheses, position information and the like.

The motion module 228 generates a motion estimate for the receiver 102. The motion module 228 can include an inertial navigation system (INS) 230 as well as a global navigation satellite system (GNSS) receiver 226 such as GPS, GLONASS, GALILEO, BEIDOU, etc. The INS 230 can include one or more of, but not limited to, a gyroscope, a magnetometer, an accelerometer, and the like. To facilitate motion compensated correlation, the motion module 228 produces motion information (sometimes referred to as a motion model) comprising at least a velocity of the antenna 202 in the direction of an emitter of interest (i.e., an estimated direction of a source of a received signal). In some embodiments, the motion information can also include estimates of platform orientation or heading including, but not limited to, pitch, roll and yaw of the platform 200/antenna 202. Generally, the receiver 102 can test a plurality of directions and iteratively narrow the search to one or more directions of interest.

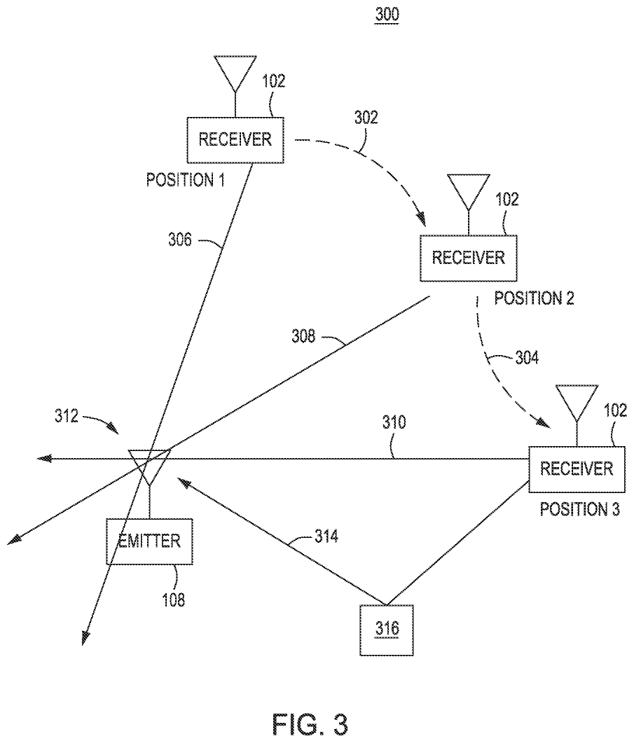

FIG. 3 depicts a graphic representation 300 of the functionality of a receiver of the present principles, such as the receiver 102 of FIGS. 1 and 2, in accordance with at least one embodiment of the present principles. In the embodiment 300 of FIG. 3, the receiver 102 moves from position 1 along path 302 to position 2, and then moves along path 304 to position 3. In the embodiment 300 of FIG. 3, as the receiver 102 traverses the area, the receiver 102 computes a first DoA vector 306 at position 1, a second DoA vector 308 at position 2 and a third DoA vector 310 at position 3. The three DoA vectors 306, 308 and 310 intersect at the location 312, which is determined to be the location of the emitter 106. Although in the embodiment 300 of FIG. 3, three discrete positions are described as locations at which the DoA vectors are computed, in other embodiments of the present principles, the DoA vectors can be computed periodically, intermittently or continuously as the receiver 102 traverses the area. As such, in various embodiments of the present principles more or less vectors can be used to converge the solution onto an accurate emitter location in accordance with the present principles.

As depicted in the embodiment 300 of FIG. 3, in various embodiments, some DoA vectors 306, 308, and 320 can be line-of-sight (LOS) and some DoA vectors 314 can be non-line-of-sight (NLOS). That is, LOS vectors represent signals that are transmitted directly from the emitter 106 to the receiver 102, while NLOS vectors can be reflected from structures 316 in the vicinity of the receiver 102. As more and more DoA vectors are collected and processed, the LOS vectors converge on a particular location (e.g., location 312). In addition, in some embodiments if TOA or TDOA information is available, the information can be used to remove DoA vectors of NLOS paths because the arrival times will be anomalous (delayed) for the NLOS signals versus the LOS signals (i.e., the time information of NLOS signals will contain a delay compared to the LOS signals).

Alternatively or in addition, in some embodiments of the present principles, structures, such as the structure 316 depicted in the embodiment 300 of FIG. 3, can be modeled using, for example, a building model. The building model in conjunction with ray tracing techniques can be used to determine the DoA of reflected signals. That is, in such embodiments of the present principles, a path of the reflected emitter signal is estimated and the reflected signals can be used in the emitter localization calculation of the present principles.

More specifically, in some embodiments a difference in the direction of signal receipt for any two or more signals received can result from a propagation path of one or more of those signals including one or more changes in direction, that is from one or more of those signals having been reflected. In this way, two sufficiently different remote source vectors, corresponding to two different transmission angles, can be obtained, and an intersection location of those vectors calculated, regardless of whether a receiver of the present principles has moved to an extent that enables triangulation of line-of-sight vectors to the signal source (emitter/antenna of a cell base station tower in a cellular network). That is, in some embodiments, by including one or more reflected signals in location determination of signal sources of the present principles, a location of a remote signal source can still be identified even if a receiver of the present principles does not move sufficiently to enable sufficiently precise triangulation based on two line-of-sight signal vectors.

More specifically, in embodiments involving the use of non-line-of-sight signals in spite of the indirect propagation paths, reflection model data can be obtained comprising a geometrical model of a set of structures capable of reflecting signals. Such a model, which can enable the calculation of remote source vectors based on DoAs of reflected signals which can be particularly useful in urban environments. In such embodiments, it can be beneficial to include a predetermined 3D building model, for example, that represents the structures that may obstruct and/or reflect transmissions. Using techniques such as ray tracing, propagation paths through such environments can be modelled in such a way that useful remote source vector information can be inferred even when the only signal received, for instance for a given position along a movement path of a receiver, is one that has been reflected by one or more structures. In some embodiments, the geometrical model can include a set of one or more structures, which can be natural or artificial, for example buildings, landscape, and terrain features. For example, in the vicinity of a receiver of the present principles, a model representing structures within a predetermined radius of, or within a region containing, an estimated or determined location of the receiver at a given time, can be obtained and used to model propagation paths. In some embodiments, the model data can include three-dimensional geometrical data representative of reflective structures and containing sufficient information about their position and/or orientation to enable a propagation path including one or more reflections to be determined.

For NLOS signals a preferential gain can be provided for a signal received by a receiver of the present principles from a first direction in comparison with a signal received from a respective, second direction. In some embodiments, the first direction can be a line-of-sight direction between the receiver and a remote source, such as an emitter/receiver of a cell base station tower in a cellular network, while the respective second direction can be a non-line-of-sight direction. In some embodiments motion compensation is performed in such a way as to provide preferential gain for a signal received along a non-line-of-sight direction, in particular where additional information is available to enable remote source vectors to be identified from such non—line-of-sight signals.

In some embodiments, one or more receivers of the present principles, such as the receiver 102 of FIGS. 1 and 2, can collect emitter signals, LOS and NLOS, from one or more emitters in an environment over a period of time while the receivers are traversing the area. The collected signals can be processed using the emitter localization techniques of the present principles to create a signal profile for the area. In accordance with the present principles, determined DoA data will contain DoA vector intersection regions that identify emitter locations. In some embodiments, a Baysian estimator can be used to compare various hypotheses as to emitter location using information provided by available measurements. Typically, vector intersection location 312 is not a point, but rather a region or area due to the probabilistic nature of the DoA vectors. That is, a determined direction of each vector has an uncertainty caused by measurement error and the intersection forms a region rather than a point. The region will have a maximum that defines the location of the emitter.

In accordance with the present principles, because a receiver of the preset principles knows its position through GNSS and/or INS calculations, the geolocation coordinates of the receiver, using determined DoA information for an emitter can be translated into a geolocation coordinates for location of an emitter(s). As such, a geolocation map of emitter locations can be generated. In various embodiments of the present principles, a receiver can determine locations for many nearby emitters sequentially and/or simultaneously.

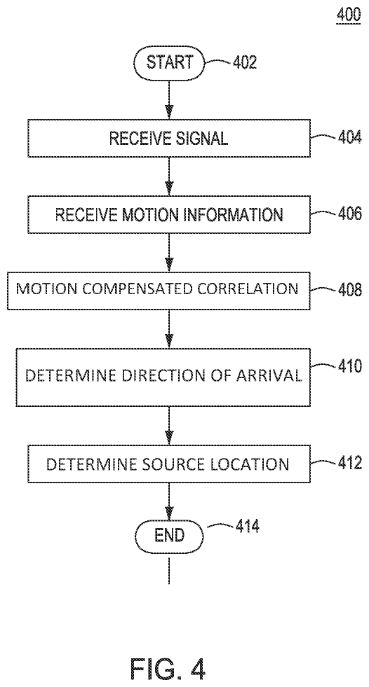

FIG. 4 depicts a flow diagram of a method 400 for determining a location of at least one emitter in accordance with an embodiment of the present principles. In some embodiments, the method 400 can be implemented using signal processing software of a signal process of the present principles, such as the signal processing software 216 of the signal processor 206 of FIG. 2.

The method 400 can begin at 402 and proceed to 404 during which at least one signal from at least one emitter is received at an antenna of at least one receiver. As described above, in some embodiments, signals can be received from at least one remote source (e.g., transmitters such as the emitters 106, 108, 110 of FIG. 1) in a manner as described with respect to FIG. 1. Each received signal can include a synchronization or acquisition code, e.g., a Gold code, which can be extracted from the radio frequency (RF) signal received at the antenna of the receiver. The method 400 can proceed to 406.

At 406, a motion of a respective antenna of the at least one receiver that received the at least one signal from the at least one emitter is determined. For example, in some embodiments, the receiver uses a single local oscillator for receiving emitter signals and for receiving GNSS signals. In such embodiments, prior to processing the emitter signals, the SUPERCORRELATION™ technique can applied to the GNSS signals to facilitate improved position accuracy and to correct local oscillator instability. Consequently, the receiver position is very accurate and the local oscillator is stable over long periods such that very long coherent integration times (e.g., 1 second) can be used in processing the GNSS signals and the emitter signals. A motion of a receiver antenna can be determined from, for example, the GNSS signals. The method 400 can proceed to 408.

At 408, motion compensated correlation is performed on the at least one signal received from the at least one emitter using the motion information determined for the respective antenna of the at least one receiver to generate at least one motion compensated correlation result. In some embodiments of the present principles, the motion compensation correlation includes correlating at least one local signal with the at least one signal from the at least one cellular emitter to generate at least one respective correlation result, generating a plurality of phasor sequences, where each phasor sequence represents a hypothesis comprising a sequence of signal phases related to a relative direction of motion of the relative antenna of the at least one receiver, compensating at least one phase of at least one of the local signal, the at least one signal of the at least one cellular emitter or the at least one correlation result, based on the generated plurality of phasor sequences, to determine at least one phase-compensated correlation result, and identifying a phasor sequence in the plurality of phasor sequences that optimizes the at least one motion compensated correlation result.

That is, in accordance with embodiments of the present principles, to perform motion compensated correlation a plurality of phasor sequence hypotheses related to a direction of interest of the received signal (i.e., direction toward an emitter) can be generated. Each phasor sequence hypothesis comprises a time series of phase offset estimates that vary with parameters such as receiver motion, frequency, DoA of the received signals, and the like. The signal processing correlates a local code encoded in a local signal with the same code encoded within the received RF signal. In one embodiment, the phasor sequence hypotheses are used to adjust, at a sub-wavelength accuracy, the carrier phase of the local signal. In some embodiments, such adjustment or compensation can be performed by adjusting a local oscillator signal, the received signal(s), or the correlation result to produce a phase compensated correlation result. The signals and/or correlation results are complex signals comprising in-phase (I) and quadrature phase (Q) components. The method applies each phase offset in the phasor sequence to a corresponding complex sample in the signals or correlation results. If the phase adjustment includes an adjustment for a component of receiver motion in an estimated direction of the emitter, then the result is a motion compensated correlation result. For each received signal, the received signals are correlated with a set (plurality) of direction hypotheses containing estimates of the phase offset sequences necessary to accurately correlate the received signals over a long coherent integration period (e.g., 1 second). There is a set of hypotheses representing a search space for each received signal.

The motion estimates are typically hypotheses of the receiver motion in a direction of interest such as in the direction of the emitter that transmitted the received signal. At initialization, the direction of interest can be unknown or inaccurately estimated. Consequently, a brute force search technique may be used to identify one or more directions of interest by searching over all directions and correlating signals received in all directions. A comparison of correlation results over all the directions enables a narrowing of the search space. There is very strong correlation between the true values of these hypotheses between code repetition, such that the initial search might be intensive, but subsequent processing only requires tracking of the parameters in the receiver as they evolve. Consequently, subsequent compensation is performed over a narrow search space.

In one embodiment, if a signal from a given emitter was received previously, the set of hypotheses for the newly received signal include a group of phasor sequence hypotheses using the expected Doppler and Doppler rate and/or last Doppler and last Doppler rate used in receiving the prior signal from that particular emitter. The values can be centered around the last values used or the last values used additionally offset by a prediction of further offset based on the expected receiver motion. Each received signal can be correlated with that signal's set of hypotheses. The hypotheses are used as parameters to form the phase-compensated phasors to phase compensate the correlation process. As such, the phase compensation can be applied to the received signals, the local frequency source (e.g., an oscillator), or the correlation result values. In addition to searching over the DoA, the hypotheses can be applied to other variables (parameters) such as oscillator frequency to correct frequency and/or phase drift (if not previously corrected) or heading to ensure the correct motion compensation is being applied. The number of hypotheses may not be the same for each variable. For example, the search space can contain ten hypotheses for searching DoA and have two hypotheses for searching a receiver motion parameter such as velocity—i.e. a total of twenty hypotheses (ten multiplied by two). The result of the correlation process is a plurality of phase-compensated correlation results—one phase-compensated correlation result value for each hypothesis for each received signal.

The correlation results can then be analyzed to find a “best” or optimal result for each received signal. The correlation output can be a single value that represents the parameter hypotheses (preferred hypotheses) that provide an optimal or best correlation output. In general, a cost function can be applied to the correlation values for each received signal to find the optimal correlation output corresponding to a preferred hypothesis or hypotheses, e.g., a maximum correlation value is associated with the preferred hypothesis. The method 400 can proceed to 410.

At 410, a direction of arrival for the at least one signal from the at least one emitter is determined using the generated phase-compensated correlation result. In some embodiments, the DoA vector of each received signal is identified from the optimal correlation result for the signal. That is, the received signals along the DoA vector typically have the strongest signal to noise ratio and represent line of sight (LOS) reception between the emitter and receiver. As such, using motion compensated correlation enables receivers of the present principles, such as the receiver 102 of FIGS. 1 and 2, to identify the DoA vectors of received signal(s).

In some embodiments of the present principles, rather than using the largest magnitude correlation value, other test criteria can be used. For example, the progression of correlations can be monitored as hypotheses are tested and a cost function can be applied that indicates the best hypotheses when the cost function reaches a minimum (e.g., a small hamming distance amongst peaks in the correlation plots). In other embodiments, additional hypotheses can be tested in addition to the DoA hypotheses to, for example, ensure the motion compensation (i.e., speed and heading) is correct. The method 400 can proceed to 412.

At 412, a location of the at least one emitter is determined using the direction of arrival determined for the at least one signal from the at least one emitter and a known position of the at least one receiver. That is, in embodiments of the present principles, the location of the at least one emitter is determined relative to a location of the receiver using DoA information determined for respective signals received from the at least one receiver. The method 400 can end at 414.

In some embodiments of the present principles, the method 400 can further include determining at least one of time of arrival (TOA) or time difference of arrival (TDOA) information for the at least one signal from the at least one emitter for assisting in the determination of the location of the at least one emitter.

In some embodiments, the processes/methods of the present principles can be iterative as additional DoA vectors are generated or can be calculated when a predefined number (e.g., three, five, ten, etc.) of DoA vectors have been determined. In such embodiments, the position computation can be augmented using TOA or TDOA information. For example, the time information related to the time a signal is received at various receiver positions can be used to identify LOS signals versus NLOS signals (e.g., NLOS signals have a delayed reception time as compared to LOS signals). DoA vectors associated with NLOS signals can then be removed from the vector set used to determine emitter location.

In some embodiments, the method can further include computing geolocation coordinates for the emitter location by translating the known geolocation coordinates of the receiver to the emitter location determined. That is, the location information for signal sources determined in accordance with the present principles includes data that can be used to derive, a geospatial coordinate, that is, data representing a position, or one or more components thereof, of the signal source, such as an emitter/antenna of a cell base station tower in a cellular network with respect to a geographic reference frame or coordinate system. Embodiments of the present principles can update a map or database with the geolocation of signal sources, such as emitters/antennas, which can also lead to the location of base stations of a cell base station tower in a cellular network, such that a comprehensive list of signal sources is created. This is advantageous as it enables more exact and accurate location data to be provided for such network elements, which again can include fixed transceiver base stations. The locations of such elements are typically known with considerably less precision.

In some embodiments, a method of the present principles can query whether another set of DoA vectors for another emitter are available for processing and repeat the process.

For example, FIG. 5 depicts a method for determining geolocation parameters for at least one cellular emitter, which in some embodiments can be performed using the location software 208 of a receiver of the present principles, such as the receiver 102 of FIGS. 1 and 2 in accordance with at least one embodiment of the present principles. The method 500 of FIG. 5 can be performed locally within the receiver or can be performed remotely on a server. If performed remotely, the DoA vectors or data to generate the DoA vectors are transmitted from the receiver to the remote server for processing in accordance with the method 500.

In the embodiment of the method 500 of FIG. 5, the method 500 begins at 502 and proceeds to 504 where DoA vectors for at least one emitter are received. The method 500 can proceed to 506.

At 506, a location where the received DoA vectors intersect is determined. In some embodiments and as described above, an emitter location is relative to the position of a receiver receiving the emitter signals. In some embodiments, DoA vectors are generated or can be calculated at a time when a predefined number (e.g., three, five, ten, etc.) of DoA vectors have been determined. In some embodiments, the determination of a location for the emitters in accordance with the present principles can be augmented using TOA or TDOA information as described above. For example, the time information related to the time a signal is received at various receiver positions can be used to identify LOS signals versus NLOS signals, e.g., NLOS signals have a delayed reception time as compared to LOS signals. In some embodiments, DoA vectors associated with NLOS signals can be removed from the vector set used to determine emitter location. The method 500 can proceed to 508.

At 508, a geolocation coordinate is determined for the at least one emitter by translating a known geolocation coordinate of the receiver to the emitter location determined at 506. The method 500 can proceed to 510.

At 510 a map or database with the emitter geolocation can be created and/or updated such that a comprehensive list of emitter geolocations is created. The method 500 can proceed to 512.

At 512, it is determined whether another set of DoA vectors for another emitter are available for processing. If the query is affirmatively answered, the method 500 returns to 504 to process additional DoA vectors. If the query is negatively answered, the method 500 ends at 514.

Embodiments of the present principles can be used to collect emitter data over time without processing the data (i.e., the emitter and receiver data is stored for subsequent processing on an as needed basis). For example, in some embodiments, an autonomous vehicle can collect and store emitter and receiver data that is processed after a traffic accident has occurred.

For example, embodiments of the present principles can be used to process collected cellular telephone data where the cellular telephone is the emitter of interest and police cars with embodiments of receivers of the present principles collect emitter data for subsequent processing. Upon a need arising, emitter data from receivers known to be in the area of an accident/crime can be processed to determine a particular cellular telephone's movement over a particular period of time. Such movement evidence can form useful evidence in an investigation. In some embodiments, to simplify the signal processing, the receiver data is processed at points where the emitter is stationary (i.e., at traffic lights or stop signs) and a path can be interpolated between the stationary points.

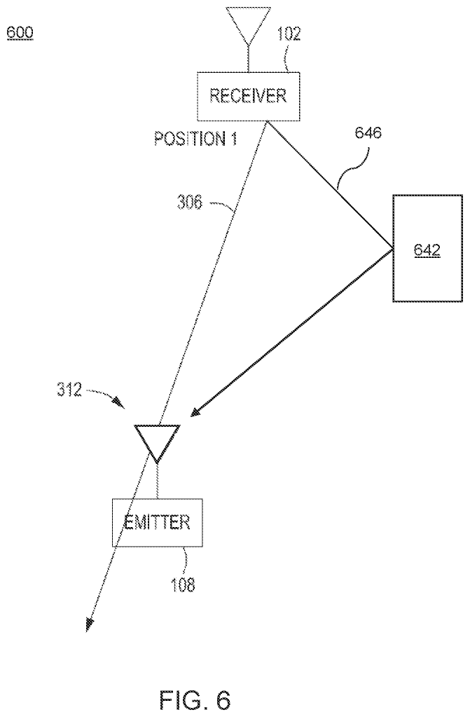

FIG. 6 depicts a graphic representation 600 of the functionality of a receiver of the present principles, such as the receiver 102 of FIGS. 1 and 2, in accordance with an alternate embodiment of the present principles. The embodiment 600 of FIG. 6 differs from the embodiment 300 depicted in FIG. 3 in that, in the embodiment 600 of FIG. 6, the receiver 102 remains substantially in position 1, rather than travelling along a path. In the embodiment 600 of FIG. 6, the receiver 102 does not traverse the area, but moves to a lesser extent than in the previously illustrated embodiment 300 of FIG. 3.

More specifically, while at position 1, and moving to the extent that motion-compensated correlation can be performed, the receiver 102 computes a DoA vector 306, similarly as described with respect to receiver 102 in the embodiment 300 of FIG. 3. In the embodiment 600 of FIG. 6, a further DoA vector 646, which is a non-line-of-sight (NLOS) vector is collected and processed by the receiver 102. In embodiment 600 of FIG. 6, a reflective structure 642 present in an urban environment has reflected a signal from the emitter 108, such that both of the line-of-sight (LOS) vector 306 and the NLOS vector 646 are DoA vectors corresponding to the same emitter 108, that is corresponding to signals transmitted by that emitter. In the embodiment 600 of FIG. 6, the structure 642 can be modelled in a building model as described above. In conjunction with a ray tracing technique, the building model is used to determine a remote source vector corresponding to a linear path between the structure 642 and the emitter 108, based on the direction of arrival vector 646. The signals are received and processed by the receiver 102 to determine a location for the emitter 108 in accordance with embodiments of the present principles described herein. In the embodiment 600 of FIG. 6, motion-compensated correlation is induced by producing motion information comprising at least a velocity of the antenna of the receiver 102 in the direction of the emitter of interest, or in a direction of receipt of a signal, including both the LOS and the NLOS signals. The motion of the receiver 102 is not depicted in the embodiment 600 of FIG. 6 since the path taken by the receiver 102 is significantly less than that undertaken by the receiver 102 in the previously described embodiment 300 of FIG. 3. In the embodiment 600 of FIG. 6, DoA vectors can be computed periodically, intermittently, or continuously, without the receiver necessarily moving through the area to the same extent as in the embodiment 300 of FIG. 3. The depicted vectors, and additional vectors corresponding to other NLOS propagation paths for signals received from the emitter 108, can be used to converge a solution onto an increasingly accurate location for the emitter 108.

Alternatively or in addition, in some embodiments of the present principles a method of obtaining location information for a remote source includes for each of a plurality of signals received at a receiver from the remote source, each of the signals being received in a respective first direction; providing a respective local signal, determining a respective movement of the receiver, providing a respective correlation signal by correlating the respective local signal with the received signal, providing motion compensation of at least one of the respective local signal, the received signal, and the respective correlation signal, based on the respective determined movement in the respective first direction to provide preferential gain for a signal received along the respective first direction and identifying, based on the said correlation, a respective remote source vector corresponding to a portion of a propagation path of the received signal, the portion being coincident with the remote source, and generating the location information for the remote source by identifying one or more locations at which two or more of the respective remote source vectors of the plurality of received signals intersect.

In some embodiments, the method can further include obtaining location information for the receiver and generating the location information for the remote source based on the location information for the receiver.

In some embodiments, the remote source can include a base station of a wireless communications system and the receiver can include user equipment of a wireless communications system.

In some embodiments, each of the plurality of signals is a portion of a transmission from the remote source received by the receiver during a respective one of a plurality of time periods.

In some embodiments, the location information for the remote source is stored in a remote source location data set which can include one or more of a geolocation map and a database and can include a geocoordinate.

In some embodiments, identifying a remote source vector for a received signal can include obtaining respective line-of-sight information indicating whether the received signal is a line-of-sight signal, identifying, based on the correlation, a respective direction of arrival, and identifying the remote source vector in accordance with the respective direction of arrival and the respective line-of-sight information. In such embodiments, reflection model data including a geometrical model of a set of structures capable of reflecting signals can be obtained, and the identifying the remote source vector in accordance with the respective direction of arrival and the respective line-of-sight information can include, if the respective line-of-sight information indicates that the received signal is not a line-of-sight signal, calculating the respective remote source vector based on the reflection model data and the respective direction of arrival. In such embodiments, time of arrival data can be determined for one or more of the plurality of received signals, where the line-of-sight information is obtained in accordance with the time of arrival data.

In some embodiments, a method for locating cellular emitters using a receiver includes performing motion compensated correlation upon at least one received signal to generate at least one motion compensated correlation result, identifying a direction of arrival for the at least one received signal using the at least one motion compensated correlation result, and determining, from the direction of arrival of the at least one received signal, the location of the cellular emitter.

In some embodiments, a system for locating cellular emitters using a receiver includes a local signal generator, configured to provide a local signal, a receiver configured to receive a signal from a remote source in a first direction, a motion module configured to provide a determined movement of the receiver, a correlation unit configured to provide a correlation signal by correlating the local signal with the received signal, a motion compensation unit configured to provide motion compensation of at least one of the local signal, the received signal, and the correlation signal based on the determined movement in the first direction, a source vector unit configured to identify, based on the said correlation, a remote source vector corresponding to a portion of a propagation path of the received signal that is coincident with the remote source and a source location unit configured to generate location information for the remote source by identifying one or more locations at which two or more respective remote source vectors of a plurality of received signals intersect.

In some embodiments, a system for performing signal correlation within a signal processing system includes at least one processor and at least one non-transient computer readable medium for storing instructions. In such embodiments when the instructions are executed by the at least one processor, the system is configured to perform operations including performing motion compensated correlation upon at least one received signal to generate at least one motion compensated correlation result, identifying a direction of arrival for the at least one received signal using the at least one motion compensated correlation result, and determining, from the direction of arrival of the at least one received signal, the location of a cellular emitter.

In some embodiments of the present principles, a computer program product includes executable instructions which, when executed by a processor, cause the processor to perform a method including, for each of a plurality of signals received at a receiver from the remote source, each of the signals being received in a respective first direction; providing a respective local signal, determining a respective movement of the receiver, providing a respective correlation signal by correlating the respective local signal with the received signal, providing motion compensation of at least one of the respective local signal, the received signal, and the respective correlation signal, based on the respective determined movement in the respective first direction to provide preferential gain for a signal received along the respective first direction, and identifying, based on the said correlation, a respective remote source vector corresponding to a portion of a propagation path of the received signal, the portion being coincident with the remote source, and generating the location information for the remote source by identifying one or more locations at which two or more of the respective remote source vectors of the plurality of received signals intersect.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with a computing device via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device can be transmitted to the computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

Any block, step, module, or otherwise described herein may represent one or more instructions which can be stored on non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present principles, other and further embodiments of the present principles may be devised without departing from the basic scope thereof, and the scope thereof is determined by the claims that follow.

1. A method for locating at least one cellular emitter, comprising:
receiving at least one signal from the at least one cellular emitter at a respective antenna of at least one receiver;
determining a motion of the respective antenna of the at least one receiver that received the at least one signal from the at least one cellular emitter;
using the determined antenna motion, performing motion compensated correlation on the at least one received signal to generate at least one motion compensated correlation result;
determining a direction of arrival for the at least one received signal using the at least one motion compensated correlation result; and
determining a location of the at least one cellular emitter using the direction of arrival of the at least one received signal and a known location of the at least one receiver.

2. The method of claim 1, wherein the at least one cellular emitter comprises two or more cellular emitters and the at least one receiver determines a location of each of the two or more cellular emitters.

3. The method of claim 2, further comprising:
creating a map of the locations of the two or more cellular emitters using the determined location of each of the two or more cellular emitters.

4. The method of claim 1, wherein at least one of the motion of the respective antenna of the at least one receiver or the known location of the at least one receiver is determined using at least signals from a Global Navigation Satellite System (GNSS).

5. The method of claim 1, wherein the at least one receiver receives the at least one signal from the at least one cellular emitter from at least three different locations and wherein the location of the at least one cellular emitter is determined using a triangulation technique.

6. The method of claim 1, wherein the at least one receiver comprises two or more receivers which receive the at least one signal from the at least one cellular emitter from at least two respective locations and wherein the location of the at least one cellular emitter is determined using data from each of the two or more receivers.

7. The method of claim 1, further comprising:
determining at least one of a time of arrival (TOA) or a time difference of arrival (TDOA) for the at least one signal from the at least one cellular emitter for use in determining the location of the at least one cellular emitter.

8. The method of claim 1, wherein performing motion compensated correlation comprises:
correlating at least one local signal with the at least one signal from the at least one cellular emitter to generate at least one respective correlation result;
generating a plurality of phasor sequences, where each phasor sequence represents a hypothesis comprising a sequence of signal phases related to a relative direction of motion of the relative antenna of the at least one receiver;
compensating at least one phase of at least one of the local signal, the at least one signal of the at least one cellular emitter or the at least one correlation result, based on the generated plurality of phasor sequences, to determine at least one phase-compensated correlation result; and
identifying a phasor sequence in the plurality of phasor sequences that optimizes the at least one motion compensated correlation result.

9. An apparatus for locating at least one cellular emitter, comprising:
at least one processor and at least one memory for storing programs and instructions that, when executed by the at least one processor, causes the apparatus to perform operations comprising:
determining a motion of a respective antenna of at least one receiver receiving at least one signal from the at least one cellular emitter;
using the determined antenna motion, performing motion compensated correlation upon the at least one received signal to generate at least one motion compensated correlation result;
determining a direction of arrival for the at least one received signal using the at least one motion compensated correlation result; and
determining a location of the at least one cellular emitter using the direction of arrival of the at least one received signal and a known location of the at least one receiver.

10. The apparatus of claim 9, wherein the at least one cellular emitter comprises two or more cellular emitters and the at least one receiver determines a location of each of the two or more cellular emitters and creates a map of the locations of the two or more cellular emitters using the determined location of each of the two or more cellular emitters.

11. The apparatus of claim 9, wherein at least one of the motion of the respective antenna of the at least one receiver or the known location of the at least one receiver is determined using at least signals from a Global Navigation Satellite System (GNSS).

12. The apparatus of claim 9, wherein the at least one receiver receives the at least one signal from the at least one cellular emitter from at least three different locations and wherein the location of the at least one cellular emitter is determined using a triangulation technique.

13. The apparatus of claim 9, wherein the at least one receiver comprises two or more receivers which receive the at least one signal from the at least one cellular emitter from at least two respective locations and wherein the location of the at least one cellular emitter is determined using data from each of the two or more receivers.

14. The apparatus of claim 9, wherein the apparatus further performs:
determining at least one of a time of arrival (TOA) or a time difference of arrival (TDOA) for the at least one signal from the at least one cellular emitter for use in determining the location of the at least one cellular emitter.

15. The apparatus of claim 9, wherein performing motion compensated correlation comprises:
correlating at least one local signal with the at least one signal from the at least one cellular emitter to generate at least one respective correlation result;
generating a plurality of phasor sequences, where each phasor sequence represents a hypothesis comprising a sequence of signal phases related to a relative direction of motion of the relative antenna of the at least one receiver;
compensating at least one phase of at least one of the local signal, the at least one signal of the at least one cellular emitter or the at least one correlation result, based on the generated plurality of phasor sequences, to determine at least one phase-compensated correlation result; and
identifying a phasor sequence in the plurality of phasor sequences that optimizes the at least one motion compensated correlation result.

16. A system for locating at least one cellular emitter, comprising:
at least one receiver comprising a respective antenna;
a motion module;
at least one cellular emitter; and
an apparatus comprising at least one processor and at least one memory for storing programs and instructions that, when executed by the at least one processor, causes the apparatus to perform operations comprising:
using the motion module, determining a motion of a respective antenna of the least one receiver receiving at least one signal from the at least one cellular emitter;
using the determined antenna motion, performing motion compensated correlation upon the at least one received signal to generate at least one motion compensated correlation result;
determining a direction of arrival for the at least one received signal using the at least one motion compensated correlation result; and
determining a location of the at least one cellular emitter using the direction of arrival of the at least one received signal and a known location of the at least one receiver.

17. The system of claim 16, wherein the at least one cellular emitter comprises two or more cellular emitters and the at least one receiver determines a location of each of the two or more cellular emitters and creates a map of the locations of the two or more cellular emitters using the determined location of each of the two or more cellular emitters.

18. The system of claim 16, wherein at least one of the motion of the respective antenna of the at least one receiver or the known location of the at least one receiver is determined using at least signals from a Global Navigation Satellite System (GNSS).

19. The system of claim 16, wherein the apparatus further performs:
determining at least one of a time of arrival (TOA) or a time difference of arrival (TDOA) for the at least one signal from the at least one cellular emitter for use in determining the location of the at least one cellular emitter.

20. The system of claim 16, wherein performing motion compensated correlation comprises:
correlating at least one local signal with the at least one signal from the at least one cellular emitter to generate at least one respective correlation result;
generating a plurality of phasor sequences, where each phasor sequence represents a hypothesis comprising a sequence of signal phases related to a relative direction of motion of the relative antenna of the at least one receiver;
compensating at least one phase of at least one of the local signal, the at least one signal of the at least one cellular emitter or the at least one correlation result, based on the generated plurality of phasor sequences, to determine at least one phase-compensated correlation result; and
identifying a phasor sequence in the plurality of phasor sequences that optimizes the at least one motion compensated correlation result.
